(19) United States
(12) Patent Application Publication
(10) Pub. No.: US 2004/0090073 A1
(43) Pub. Date: May 13, 2004

(54) Bag dispenser incorporated into handle of a scoop

(76) Inventors: Timothy Edwards, Del Mar, CA (US); Mary Edwards, Del Mar, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/350,485

(22) Filed: Jan. 23, 2003

Related U.S. Application Data
(63) Continuation-in-part of application No. 29/170,969, filed on Nov. 13, 2002, now Pat. No. D485025.

(51) Int. Cl. A01K 29/00

(52) U.S. Cl. 294/1.3; 294/55; 209/418

(57) ABSTRACT

A scoop is formed in traditional manner with a head having a blade at one end, and a handle having a proximal end extending from the head. A bag dispenser is associated with the distal end of the handle. A plurality of bags, such as a roll of bags detachably connected to one another, are disposed within the bag dispenser for selective and individual removal from a dispensing window thereof. Preferably, the bag dispenser is integrally formed with the handle.

### RELATED APPLICATION

This is a continuation-in-part of U.S. patent application Ser. No. 29/170,969, filed Nov. 13, 2002.

### BACKGROUND OF THE INVENTION

The present invention generally relates to scoops and the like. More particularly, the present invention resides in a bag dispenser which is incorporated into a handle of a scoop.

There are many instances in which a scoop and a plastic bag are used. For instance, in grocery stores and the like, there are often found bins of product, such as candy, nuts, etc. Often there is a central source of plastic bags, similar to produce bags, which can be individually removed and a scoop is used to insert the product from the bin into the bag. However, it is often the case that either the source of bags is empty, cannot be located, or the scoop cannot be located. In other instances, it is necessary to traverse between the source of bags and the bin containing the intended product several times if different products from different bins are collected or purchased.

Another instance in which a scoop and a bag, or container, is used is in the instance of a litter box wherein excrement is removed from the litter box with the scoop and disposed of in a container, such as a garbage can or bag. Such droppings are usually malodorless and placement of the droppings into a garbage can merely provides a foul odor in a different part of the house unless the garbage is immediately disposed of. Alternatively, a plastic or paper bag is used in which to immediately dispose of the droppings. However, the pet owner must obtain a bag, such as a small kitchen garbage bag, and then use the scoop to insert the droppings into the bag.

In yet another instance, when walking a dog, it is necessary to retrieve the excrement, often due to local ordinances and laws. Small plastic bags are the preferred method of storing such pet excrement. Often, the pet owner will carry a small scoop, shovel, or blade in which to scoop or lift the pet excrement into the plastic bag.

Accordingly, there is a continuing need for a scoop which has a bag dispenser incorporated into a handle thereof. The present invention fulfills this need and provides other related advantages.

### SUMMARY OF THE INVENTION

The present invention resides in a scoop having a bag dispenser in order to conveniently supply a source of disposable bags with a scoop. The scoop comprises a head having a blade at one end, and having a handle extending from the head.

A bag dispenser is associated with a distal end of the handle. The bag dispenser may be removably attached to the end of the handle, but more preferably is integrally formed with the handle.

A plurality of bags are disposed within the bag dispenser for their selective and individual removal from a dispensing window thereof. The plurality of bags preferably comprises a roll of bags detachably connected to one another. Means are provided for retaining the roll of bags within the housing. Such means may comprise a removable lid configured to enclose the open end of the housing or a spring clip extending over the open end for compressible contact with the bags.

Means are also provided for centrally and rotationally retaining the roll of bags within the housing. Such retaining means may comprise a tubular axle about which the bags are rolled in contact with axle guides protruding from opposite ends of the housing which engage the tubular axle such that the tubular axle and thus the roll of bags may rotate within the housing.

The bag dispenser itself may comprise a generally cylindrical housing having an open end permitting access to an inner cavity thereof for insertion of the bags, and means for retaining the bags within the housing, such as the lid or spring clip. Alternatively, the bag dispenser may comprise first and second housing portions which are pivotally connected to one another and capable of being locked to one another to form an interior cavity which houses the bags.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a scoop embodying the present invention supported by a holder also supporting a roll of bags;

FIG. 2 is a partially exploded perspective view of FIG. 1;

FIG. 3 is a partially exploded perspective view of the scoop of FIG. 2, illustrating placement of a roll of bags therein;

FIG. 4 is a cross-sectional view taken generally along line 4-4 of FIG. 2, illustrating means for centrally and rotationally retaining the roll of bags within a dispenser of the scoop;

FIG. 5 is a cross-sectional view taken generally along line 5-5 of FIG. 2; in a bag dispensing portion of the scoop;

FIG. 6 is a front elevational view of the scoop and holder of FIG. 1;

FIG. 7 is a partially exploded perspective view of the holder and a roll of bags for the dispenser;

FIG. 8 is a side elevational view of the scoop secured within the holder;

FIG. 9 is a perspective view of another scoop having a bag dispenser incorporated therein secured within a holder having an extra roll of bags therein;

FIG. 10 is a side elevational view of the scoop and holder of FIG. 9;

FIG. 11 is a perspective view of yet another scoop having a bag dispenser embodying the present invention;

FIG. 12 is cross-sectional view taken generally along line 12-12 of FIG. 11, illustrating the roll of bags centrally and rotationally retained within the bag dispenser;

FIG. 13 is a partially exploded perspective view illustrating the removal/insertion of a roll of bags into an open housing of the bag dispenser;

FIG. 14 is a partially fragmented and exploded perspective view of another scoop having a bag dispenser removably attached thereto;

FIG. 15 is a partially fragmented perspective view illustrating the bag dispenser disposed within the end of the handle;

FIG. 16 is a perspective view of a bag dispenser attached to an end of the handle; and

FIG. 17 is a partially fragmented perspective view of the bag dispenser removed from a slot of the handle.

### DETAILED DESCRIPTION OF THE PREFERRED EMBODIMENTS

As shown in the accompanying drawings for purposes of illustration, the present invention resides in a scoop having a bag dispenser associated therewith for providing selective and individual removal of bags for storage of items lifted by the scoop.

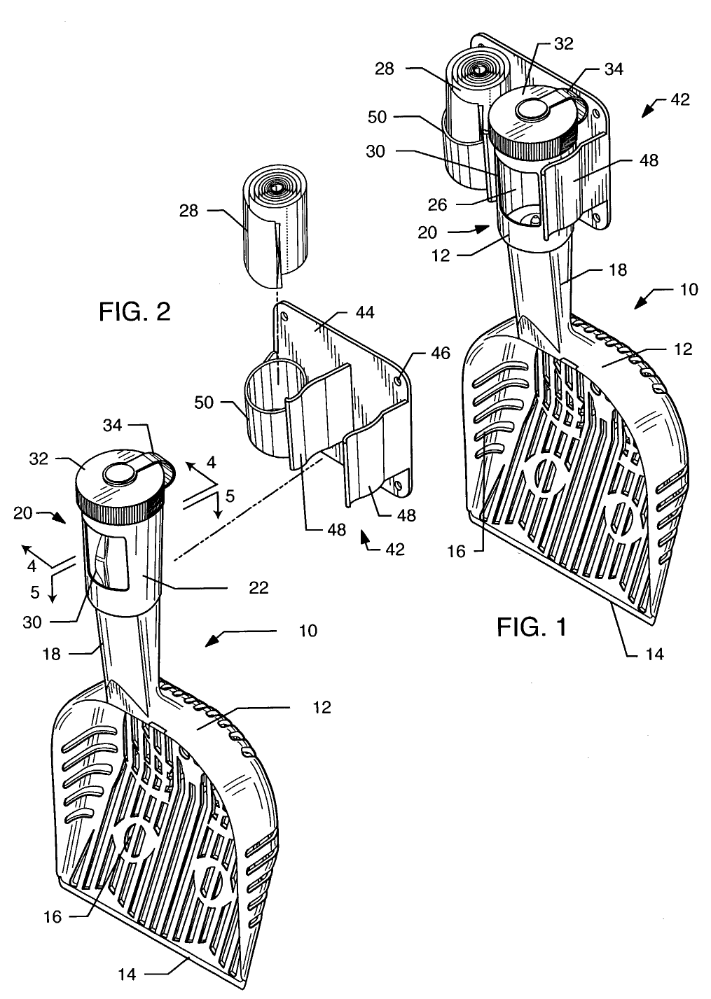

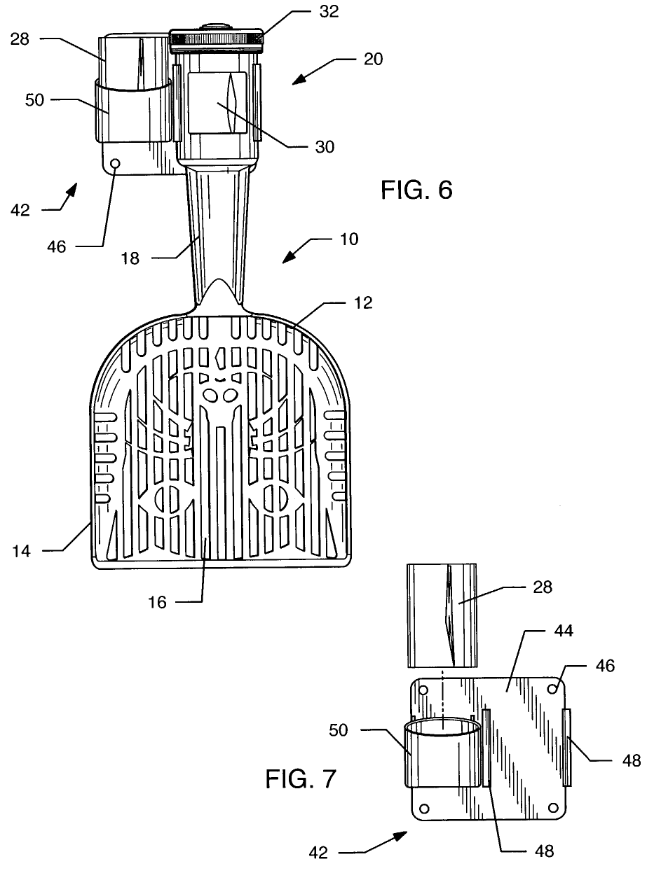

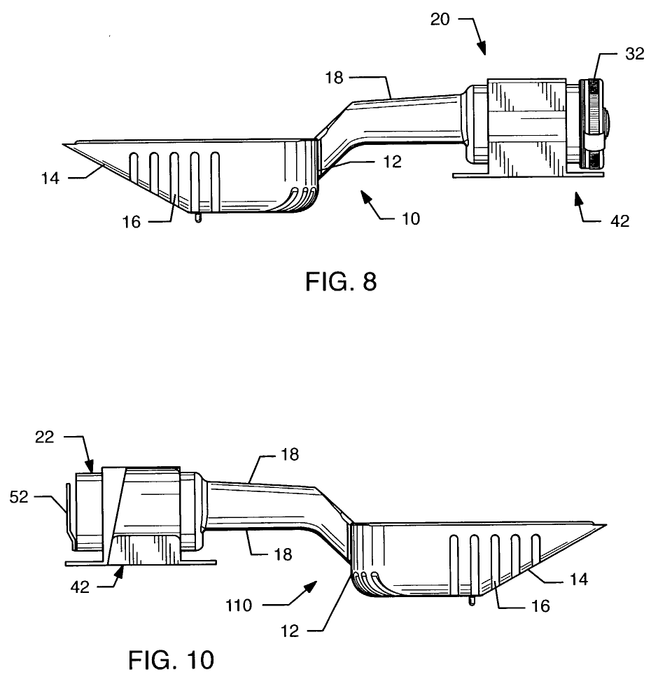

With reference now to FIGS. 1-8, a first preferred embodiment of a scoop 10 is illustrated. The scoop 10 has a head 12 with a blade 14 extending from the head 12 and configured to scoop in normal fashion. As illustrated, the blade 14 portion of the scoop 10 may include slots or apertures which is particularly useful when removing pet excrement from a litter box, such that the pet excrement is retained within the blade 14 portion of the scoop 10 while the cat litter falls through the apertures and slits 16.

A handle 18 extends from an opposite end of the head 12 as the blade 14. A bag dispenser 20 is associated with the handle 18. The bag dispenser 20 may be removably attached to a distal end of the handle 18, or integrally formed with the handle 18. In fact, the bag dispenser 20 may actually be grasped by the user of the scoop 10 and thus serve as a portion of the handle 18.

The bag dispenser 20 is typically comprised of a generally cylindrical housing 22 having an open end 24 which permits access to an inner cavity 26 which is configured to receive a plurality of bags 28 therein. Although the bags may be folded, etc., the bags are typically in the form of a roll of bags detachably connected to one another, as illustrated.

In order to selectively and individually remove the bags 28 from the bag dispenser 20, an opening, such as the illustrated window 30 is formed in the housing. Further, means are provided for retaining the bags 28 within the housing 22. As illustrated in FIGS. 1-8, such means comprises a removable lid 32 which is screwed onto, snap-fit onto, etc. the open end 24 of the housing 22, as illustrated. The lid 32 may include a tether 34 interconnected between the housing 22 and the lid 32 such that when the lid 32 is removed from the housing 22, it is not lost but rather remains attached to the scoop 10.

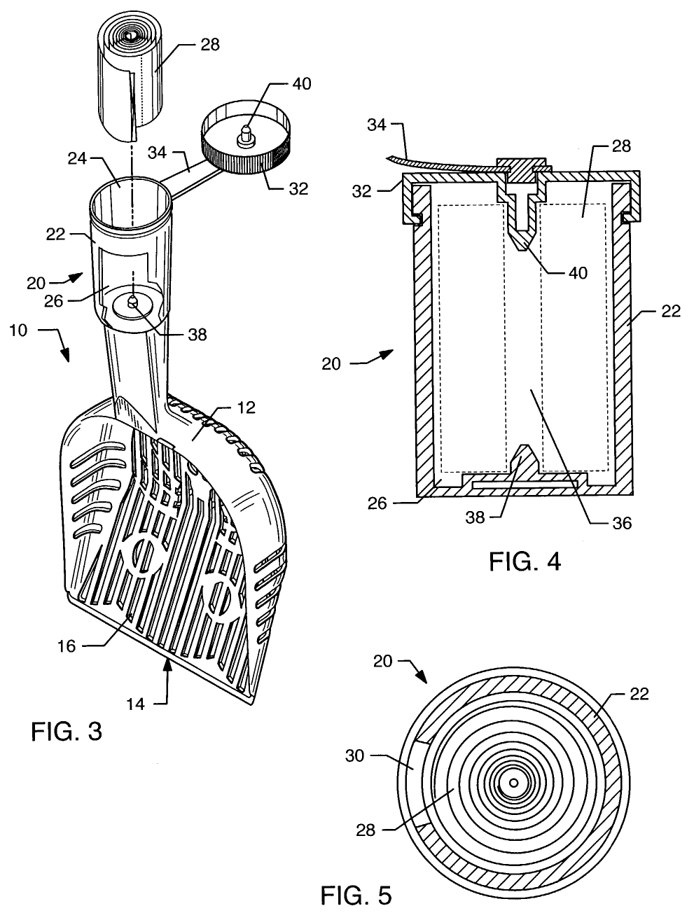

With particular reference to FIGS. 3 and 4, means are provided for centrally and rotationally retaining the roll of bags 28 within the housing 22. As illustrated, such means typically comprises a tubular axle 36 about which the bags are rolled, which may comprise a plastic or cardboard tube which is hollow. A lower axle guide 38 protrudes from a lower en d of the housing 22 and is configured so as to be inserted into the tubular axle 36 of the roll of bags 28. An upper axle guide 40 is formed on the lid such that when the lid 32 is closed, the upper axle guide 40 is inserted into the hollow portion of the axle 36 of the roll of bags 28. Thus, the roll of bags is centrally retained within the housing 22, and allowed to be rotated in order to remove the individual bags 28 from the window 30.

With reference to FIGS. 1, 2 and 6-8, a holder 42 may be provided for conveniently storing the scoop 10, and even an extra roll of bags 28. The holder 42 is preferably comprised of a back plate 44 having apertures 46 through which nails or screws can be inserted for mounting the holder 42 on a wall. Resiliently flexible fingers 48 are spaced from one another so as to frictionally retain the handle 18 or bag dispenser 20 therebetween. A generally cylindrical stand 50 may be attached to the holder 42 which is configured to receive a roll of bags 28, as illustrated.

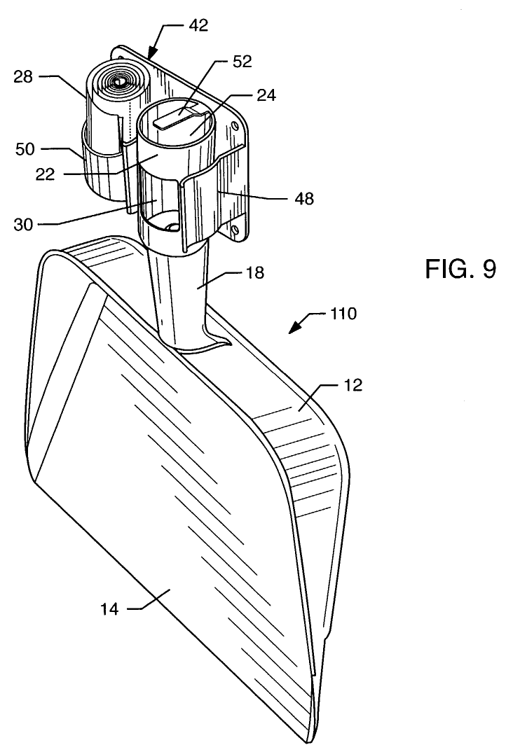

With reference now to FIGS. 9 and 10, another embodiment of the scoop 110 is illustrated. Those structural features which are in common with the above-described scoop 10 are identified by the same reference numbers. The scoop 110 includes a head 12 having a blade 14 extending away therefrom in order to scoop up product, pet excrement, etc. A handle 18 extends opposite the blade 14 for grasping by the user of the scoop 110. The bag dispenser 20 is attached and integrally formed with the handle 18, typically at a distal end thereof. Once again, the housing 22 is generally cylindrical, or matching that of the handle 18. The housing 22 is configured to removably receive the roll of bags 28 therein through an open end 24 of the housing 22. Once again an aperture, such as the illustrated window 30 allows the user to selectively remove bags 28 therefrom. However, instead of utilizing a detachable lid, the means for retaining the roll of bags 28 within the housing 22 comprises a spring clip 52 which is attached to an end of the housing 22 and extends over the open end 24 of the housing 22 for compressible contact with the roll of bags 28. The spring clip 52 may be capable of being lifted upward to allow the roll of bags 28 to be inserted into the bag dispenser 20. Alternatively, the spring clip 52 is pivotally attached to the housing 22 such that it can be moved over the open end 24 once the roll of bags 28 has been inserted therein. The spring clip 52 may include an upper axle guide (not shown), as described above, which cooperates with the lower axle guide for centrally and rotationally retaining the roll of bags 28 within the housing 22.

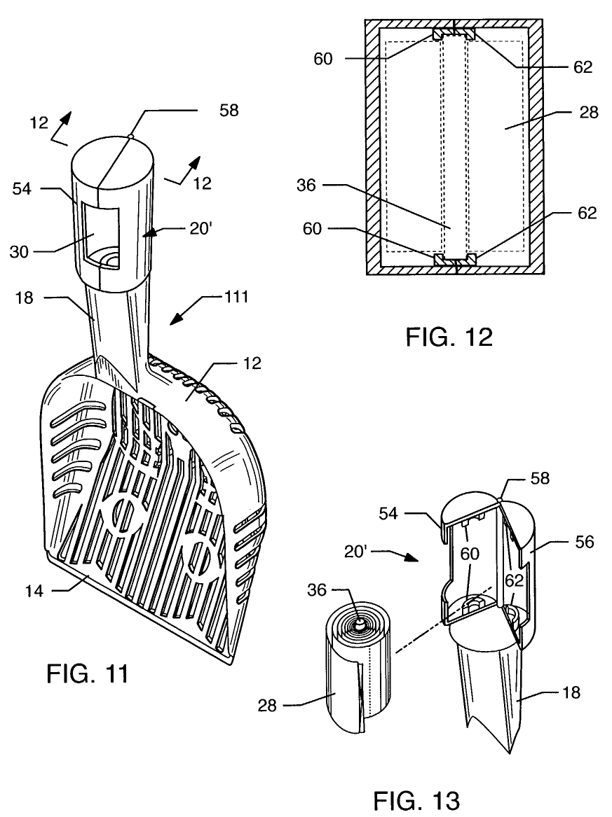

With reference now to FIGS. 11-13, yet another scoop 111 is illustrated. Once again, the scoop includes a head 12 having a blade 14 extending therefrom for lifting and scooping materials. A bag dispenser 20′ is attached to or formed integrally with the handle 18. Typically, the bag dispenser 20′ is located at a distal end of the handle 18, as illustrated.

As shown in FIGS. 11 and 13, the bag dispenser 20′ is comprised of first and second housing portions 54 and 56 which are generally semi-cylindrical in shape and which are pivotally connected to one another at hinge 58. As illustrated in FIG. 13, on opening the housing portions 54 and 56, a roll of bags 28 can be inserted therein. Each section 54 and 56 includes a cut-out which when brought together forms a window 30, as illustrated in FIG. 11. The portions 54 and 56 can be brought to one another and locked in place to retain the roll of bags 28 in the inner cavity formed thereby.

The scoop 111 preferably includes means for centrally and rotationally retaining the roll of bags 28 within the dispenser 20′. As illustrated in FIGS. 12 and 13, the roll of bags 28 typically has ends of the axle 36 which extends slightly beyond the bags themselves, such as by ⅛″ or ¼″. A lower axle guide 38 can be formed at the base of the dispenser 20′. Alternatively, and more preferably, semi-circular axle guides 60 and 62 extend from upper and lower ends of the housing portions 54 and 56. When the housing portions 54 and 56 are closed upon one another, the axle guide 60 and 62 form a generally circular or cylindrical guide encircling the exposed portion of the axle 36, thus centrally and rotationally retaining the roll of bags 28 within the dispenser 20′.

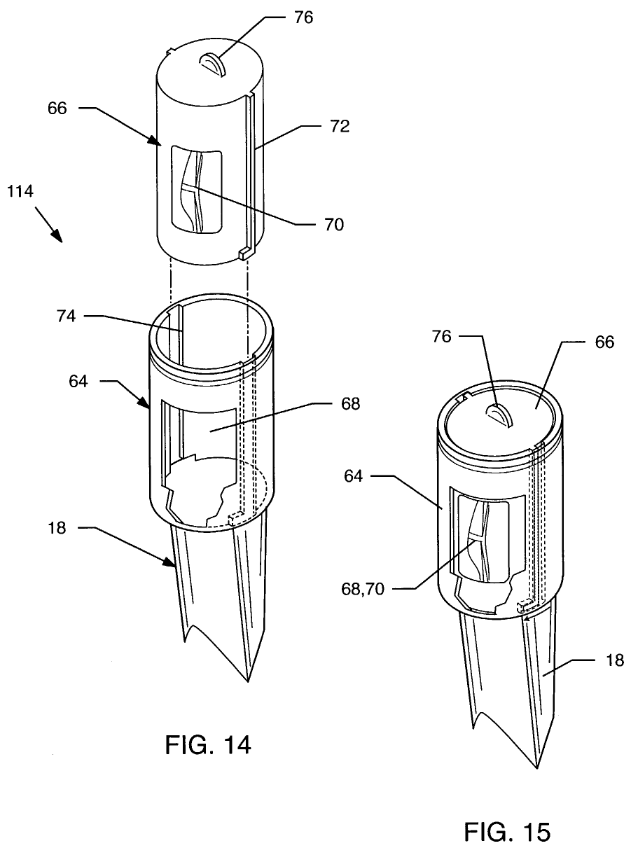

With reference now to FIGS. 14 and 15, another scoop 114 is partially illustrated wherein the distal end 64 of the handle 18 is hollow and open-ended so as to removably receive a bag dispenser 66 therein. The hollow end 64 is preferably integrally formed with the handle 18, although the hollow portion 65 may be attached, such as by frictional fit, screws or the like. Preferably, the hollow end 64 includes a window 68 which registers with a window 70 of the bag dispenser 66 so that bags 28 may be removed therefrom. The bag dispenser 66 may be securely received within the hollow end portion 64 by any means, such as frictional fit, etc. In the illustrated embodiment, the bag dispenser 66 includes protrusions 72 which are received within slots 74 of the hollow end 64. Once inserted, the bag dispenser 66 may be turned, such as by a quarter-turn, to lock it in place. The bag dispenser 66 may rest above an upper edge of the end 64 of the handle 18 so as to be selectively removed, or a finger hold 76 or the like. The bag dispenser 66 may be disposable so as to be used only once, or the bag dispenser 66 may include retaining means, such as a cap or lid, so that a roll of bags 28 may be inserted therein as needed.

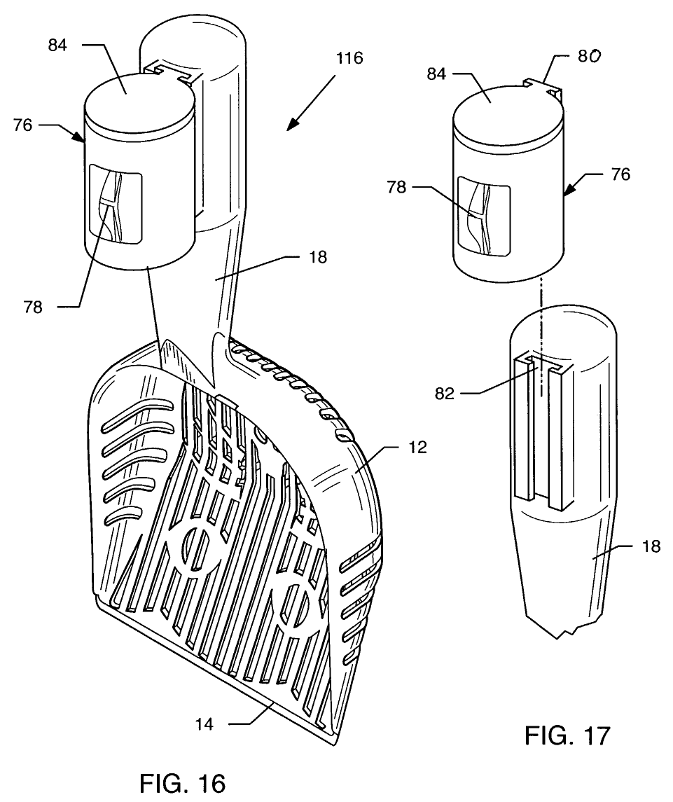

With reference now to FIGS. 16 and 17, yet another scoop 116 embodying the present invention is illustrated. A bag dispenser 76 includes walls forming a generally cylindrical enclosure so as to accommodate a roll of bags 28 therein. Of course, other configurations are also within the realm of the invention. The bag dispenser 76 includes a window 78 for the selective and individual removal of the bags 28 within the dispenser 76. The dispenser 76 is associated with the handle 18 of the scoop 116. This is done by removably attaching the dispenser 76 to the handle 18. In the particularly preferred embodiment which is illustrated, the bag dispenser 76 includes a protrusion 80 which mates with a corresponding recess 82 of the handle 18. In a particularly preferred embodiment, the protrusion 80 comprises a rail which is slidably received within a groove or slot 82 of the handle 18. The groove 82 may be formed integrally with the handle 18 during the manufacturing process, or a plate which includes the groove 82 for the acceptance of the tongue 80 protrusion can be adhered or otherwise fixed to the handle 18 so that existing scoops may be retrofitted to accommodate the present invention. Of course, it will be appreciated by those skilled in the art that the handle 18 may include the protrusion 80, while the bag dispenser 76 includes the recess or groove 82. The important aspect is that the bag dispenser 76 is removably received onto the handle 18. As described above, the bag dispenser 76 may be a one-time use dispenser which is disposable after the bags 28 have been exhausted, or it may include a lid 84, as illustrated so that rolls of bags 28 may be inserted within the dispenser 76 as needed.

Although several embodiments have been described in some detail for purposes of illustration, various modifications may be made without departing from the scope and spirit of the invention. Accordingly, the invention is not to be limited, except as by the appended claims.

What is claimed is:

1. A scoop, comprising:
a head having a blade at one end;
a handle having a proximal end extending from the head;
a bag dispenser associated with a distal end of the handle and having a dispensing window; and
a plurality of bags disposed within the bag dispenser for selective individual removal from the dispensing window.

2. The scoop of claim 1, wherein the bag dispenser is removably attached to the end of the handle.

3. The scoop of claim 1, wherein the bag dispenser is integrally formed with the handle.

4. The scoop of claim 1, wherein the plurality of bags comprises a roll of bags detachably connected to one another.

5. The scoop of claim 4, wherein the bag dispenser comprises a generally cylindrical housing having an open end permitting access to an inner cavity thereof for insertion of the bags and means for retaining the bags within the housing.

6. The scoop of claim 5, wherein the retaining means comprises a removable lid configured to enclose the open end of the housing.

7. The scoop of claim 5, wherein the retaining means comprises a spring clip extending over the open end for compressible contact with the bags.

8. The scoop of claim 5, including means for centrally and rotationally retaining a roll of bags within the housing.

9. The scoop of claim 8, wherein the retaining means comprises a tubular axle about which the bags are rolled, a lower axle guide protruding from a lower end of the housing, and an upper axle guide protruding from a lid or upper end of the housing, the axle guides engaging with the tubular axle such that the tubular axle, and thus the roll of bags, may rotate within the housing.

10. The scoop of claim 1, wherein the bag dispenser comprises first and second housing portions pivotally connected to one another and capable of being locked to one another to form an interior cavity adapted to house the bags.

11. The scoop of claim 10, wherein the bags comprise a roll of bags detachably connected to one another, and including means for centrally and rotationally retaining a roll of bags within the housing.

12. The scoop of claim 2, wherein the distal end of the handle is hollow and configured to removably receive the bag dispenser therein.

13. The scoop of claim 2, wherein the bag dispenser includes a protrusion which mates with a recess of the handle.

14. A scoop, comprising:
a head having a blade at one end;
a handle having a proximal end extending from the head;
a bag dispenser associated with a distal end of the handle and having a dispensing window;
a roll of bags detachably connected to one another disposed within the bag dispenser for selective individual removal from the dispensing window; and
means for retaining the roll of bags within the housing.

15. The scoop of claim 13, wherein the bag dispenser is removably attached to the end of the handle.

16. The scoop of claim 14, wherein the bag dispenser is integrally formed with the handle.

17. The scoop of claim 14, wherein the bag dispenser comprises a generally cylindrical housing having an open end permitting access to an inner cavity thereof for insertion of the bags.

18. The scoop of claim 14, wherein the retaining means comprises a removable lid configured to enclose the open end of the housing.

19. The scoop of claim 14, wherein the retaining means comprises a spring clip extending over the open end for compressible contact with the bags.

20. The scoop of claim 14, including means for centrally and rotationally retaining a roll of bags within the housing.

21. The scoop of claim 20, wherein the retaining means comprises a tubular axle about which the bags are rolled, a lower axle guide protruding from a lower end of the housing, and an upper axle guide protruding from a lid or upper end of the housing, the axle guides engaging with the tubular axle such that the tubular axle, and thus the roll of bags, may rotate within the housing.

22. The scoop of claim 15, wherein the distal end of the handle is hollow and configured to removably receive the bag dispenser therein.

23. The scoop of claim 15, wherein the bag dispenser includes a protrusion which is slidably received within a slot of the handle.

24. A scoop, comprising:
a head having a blade at one end;
a handle having a proximal end extending from the head;
a bag dispenser associated with a distal end of the handle and comprising first and second housing portions pivotally connected to one another and capable of being locked to one another to form an interior cavity and a dispensing window; and
a roll of bags detachably connected to one another and disposed within the bag dispenser cavity for selective individual removal from the dispensing window.

25. The scoop of claim 24, wherein the bag dispenser is removably attached to the end of the handle.

26. The scoop of claim 24, wherein the bag dispenser is integrally formed with the handle.

27. The scoop of claim 24, including means for centrally and rotationally retaining a roll of bags within the dispenser.

28. The scoop of claim 27, wherein the retaining means comprises a tubular axle about which the bags are rolled, a lower axle guide protruding from a lower end of the housing, and an upper axle guide protruding from a n upper end of the housing, the axle guides engaging with the tubular axle such that the tubular axle, and thus the roll of bags, may rotate within the housing.

29. The scoop of claim 25, wherein the distal end of the handle is hollow and configured to removably receive the bag dispenser therein.

30. The scoop of claim 25, wherein the bag dispenser includes a protrusion which is slidably received within a slot of the handle.
